(19) United States
(12) Patent Application Publication
(10) Pub. No.: US 2024/0140338 A1
(43) Pub. Date: May 2, 2024

(54) ELECTROSTATIC ELIMINATING DEVICE AND VEHICLE

(71) Applicants: Futaijing Precision Electronics (Yantai) Co., Ltd., Yantai (CN); HON HAI PRECISION INDUSTRY CO., LTD., New Taipei (CN)

(72) Inventor: YU-LUN HUANG, New Taipei (TW)

(73) Assignees: Futaijing Precision Electronics (Yantai) Co., Ltd., Yantai (CN); HON HAI PRECISION INDUSTRY CO., LTD., New Taipei (TW)

(21) Appl. No.: 18/138,107

(22) Filed: Apr. 23, 2023

(30) Foreign Application Priority Data
Oct. 28, 2022 (CN) 202211332106.2

(51) Int. Cl. B60R 16/06

(52) U.S. Cl. CPC B60R 16/06; E05B 85/10

(57) ABSTRACT

An electrostatic eliminating device comprises an electrostatic input terminal, an electrostatic absorption circuit, an electrostatic output terminal. The electrostatic absorption circuit is configured to absorb static electricity accessed to the input end of the electrostatic absorption circuit. The electrostatic input terminal is connected with the door handle, and the electrostatic output terminal is connected with the door handle or the human body to form a circuit, so that the electrostatic ab sorption circuit can absorb the incoming electrostatic charges to avoid the concentration of electrostatic charges on the door handle, which may cause the user to feel electric shock when touching the door handle.

### TECHNICAL FIELD

The subject matter herein generally relates to vehicle.

### BACKGROUND

In the process of driving, the car rubs against the dust on the ground and in the air, resulting in a large number of electrostatic charges carried on the car, and users may feel an electric shock when touching the door handle of the car.

### BRIEF DESCRIPTION OF THE DRAWINGS

Implementations of the present technology will now be described, by way of example only, with reference to the attached figures.

FIG. 1 is a diagram of one embodiment of an electrostatic eliminating device according to the present application.

FIG. 2 is a diagram of another embodiment of an electrostatic eliminating device according to the present application.

FIG. 3 is a diagram illustrating a human body touching a door handle of a vehicle comprising the electrostatic eliminating device in one embodiment.

FIG. 4 is a diagram of one embodiment of an electrostatic absorption circuit according to the present application.

FIG. 5 is a diagram of another embodiment of an electrostatic absorption circuit according to the present application.

FIG. 6 is a diagram of one embodiment of a vehicle according to the present application.

FIG. 7 is a diagram of another embodiment of a vehicle according to the present application.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

In people's daily life, static electricity will bring trouble and harm in many cases. When the electrostatic discharge voltage is lower than 3000V, the human body does not feel it; when the voltage is greater than 3000V, the human body will feel a slight feeling of numbness; when the voltage is greater than 6000V, the human body feeling is uncomfortable. In the process of car driving, the metal body rubs against the dust on the ground and in the air, producing a large number of electrostatic charges carried on the car. When people touch the car, discharge phenomenon occurs. Especially the car door handle, the rear door switch and the steering wheel, which are the parts direct contact with the human body most frequently. The human body is more likely to produce electrostatic charges in dry weather, and encounters the situation of electrostatic shock. Today's cars also adopt some anti-static measures, such as attaching a chain to the back of the car or using an antenna, but most of them adopt external devices to transmit or counteract the electrostatic charges by touching the car body.

FIG. 1 is a diagram of an electrostatic eliminating device 100 in one embodiment of the present application. The electrostatic eliminating device 100 can be set in a vehicle 1 and is configured to absorb the electrostatic charges carried on the vehicle 1. The vehicle 1 comprises a door handle.

The electrostatic eliminating device 100 comprises an electrostatic input terminal 10, an electrostatic absorption circuit 20, and an electrostatic output terminal 30. The electrostatic input terminal 10 is electrically connected with the door handle 200. An input end of the electrostatic absorption circuit 20 is electrically connected with the electrostatic input terminal 10, the electrostatic absorption circuit 20 is configured to absorb static electricity accessed to the input end of the electrostatic absorption circuit 20. The electrostatic output terminal 30 is electrically connected with an output end of the electrostatic absorption circuit 20, the electrostatic output terminal 30 is configured to electrically connected with the door handle 200 or a human body.

In one embodiment, the electrostatic input terminal 10 and the electrostatic output terminal 30 are electrically connected to the door handle 200, so that the electrostatic input terminal 10, the electrostatic absorption circuit 20, the electrostatic output terminal 30, and the door handle 200 form a loop in series. The electrostatic charges concentrated on the door handle 200 flow into the loop through the electrostatic input terminal 10 and is absorbed when it passes through the electrostatic absorption circuit 20. In this way, as long as there is electrostatic charge on the door handle 200, it will be absorbed by the electrostatic absorption circuit 20, so that there is no electrostatic charge concentrates on the door handle 200, and no static electricity will occur when the user touches the door handle 200.

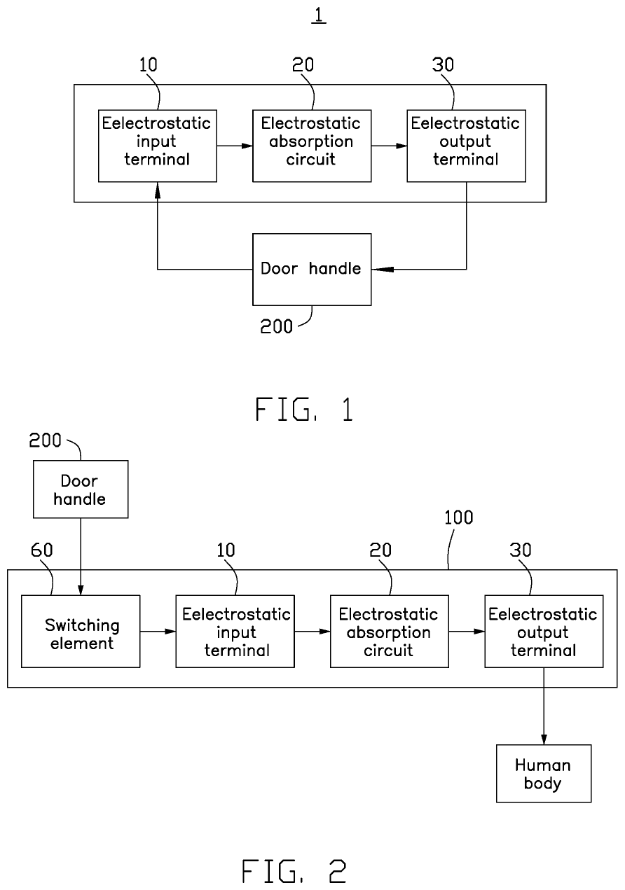

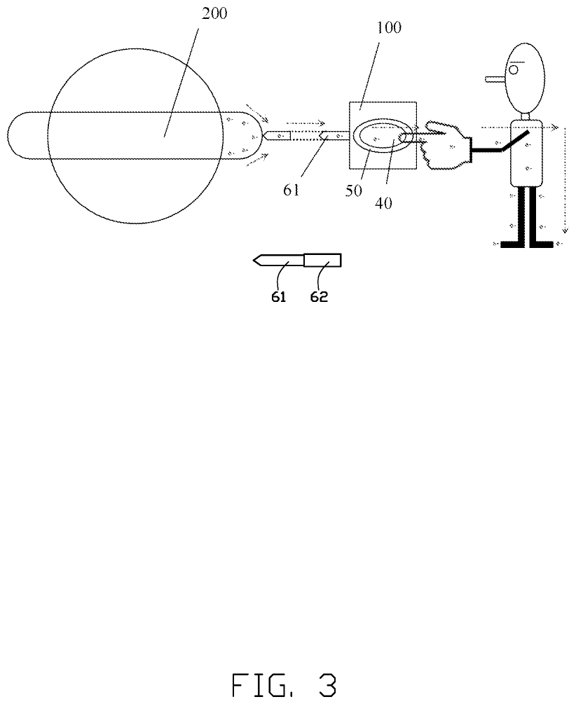

FIG. 2 is a diagram of an electrostatic eliminating device in another embodiment of the present application.

In one embodiment, the electrostatic input terminal 10 is electrically connected to the door handle 200, and the electrostatic output terminal 30 is arranged on the door handle 200 and is not electrically connected with the door handle 200. When the human body touches the electrostatic output terminal 30 on the door handle 200, the door handle 200, the electrostatic input terminal 10, the electrostatic absorption circuit 20, the electrostatic output terminal 30, the human body, and the ground form a loop, the electrostatic charges on the door handle 200 flow into the loop through the electrostatic input terminal 10. After passing through the electrostatic absorption circuit 20, the electrostatic charges are absorbed into a small current, and finally flows through the human body into the ground. In this way, when the human body touches the door handle 200, the electrostatic current passing through the human body usually cannot be felt by most people, so as not to bring electric shock to the human body.

In this embodiment, the electrostatic output terminal 30 can be an independent key or contact area set on the door handle 200. When the human finger touches the electrostatic output terminal 30 for a few seconds, the electrostatic charges concentrated on the door handle 200 can flow to the ground through the human body and consumed. Since most of the electrostatic charges have been absorbed by the electrostatic absorption circuit 20, the tiny current transmitted to the human body cannot be felt by most users. At this time, the electrostatic charges on the door handle 200 have been eliminated, and the user will not be shocked by static electricity when touching the door handle 200 again.

In one embodiment, the electrostatic input terminal 10 can be electrically connected to the door handle 200 through a wire, or by etching a metal wire on the inside of the door 300.

The electrostatic input terminal 10 is electrically connected to the door handle 200 and the electrostatic output terminal 30 is electrically connected to the door handle 200 or the human body to form a loop. So that the electrostatic absorption circuit 20 can absorb the incoming electrostatic charges to avoid the electrostatic charges to concentrate on the door handle 200 and causing the user to feel electric shock when touching the door handle 200.

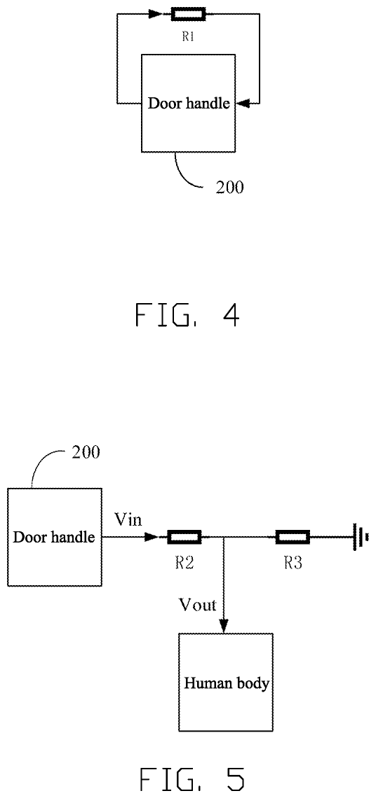

FIG. 4 is a diagram of an electrostatic absorption circuit in one embodiment of the present application.

In one embodiment, the electrostatic absorption circuit 20 comprises a first resistor R1, one end of the first resistor R1 acts as the input end of the electrostatic absorption circuit 20, another end of the first resistor R1 acts as the output end of the electrostatic absorption circuit 20, the first resistor R1 is configured to absorb the static electricity.

In this embodiment, the first resistor R1 is connected in series with the door handle 200 to form a circuit, or the first resistor R1 is electrically connected with the door handle 200 and the human body respectively to form a loop. It is understood that the electrostatic current will generate power consumption when passing through the first resistor R1. In this way, the amount of electrostatic charges can be reduced, thus reducing the possibility of electrostatic phenomenon when the user touches the door handle 200.

FIG. 5 is a diagram of an electrostatic absorption circuit in one embodiment of the present application.

In one embodiment, the electrostatic absorption circuit 20 comprises a second resistor R2 and a third resistor R3, one end of the second resistor R2 acts as the input end of the electrostatic absorption circuit 20, the second resistor R2 is configured to absorb the static electricity accessed to the input end of the second resistor R2, one end of the third resistance R3 is electrically connected with another end of the second resistor R2 to form the output end of the electrostatic absorption circuit 20, and another end of the third resistance R3 is grounded.

In this embodiment, the second resistor R2 and the third resistor R3 constitute a voltage dividing circuit. As can be seen from the formula Vout=Vin*R3/(R2+R3), due to the voltage dividing of the second resistance R2, the output voltage of electrostatic output terminal 30 is less than the input voltage of electrostatic input terminal 10, reducing the electric shock sensation of human body when the human body touches the electrostatic output terminal 30.

In one embodiment, a resistance value of the second resistor R2 is greater than a resistance value of the third resistor R3. In this way, the voltage at the electrostatic output terminal of 30 can be further reduced, so that the electrostatic voltage transmitted to the human body is close to insensible. For example, if the second resistor R2 is 900Ω, and the third resistor R3 is 100Ω. When the electrostatic voltage is 30V, the Vout is 27V, the voltage at the electrostatic output terminal 30 is 3V.

Referring to FIG. 2, the electrostatic eliminating device 100 further comprises a conductive part 40 and an insulated part 50, the conductive part 40 is arranged on the outer surface of the door handle 200, the conductive part 40 is electrically connected with the electrostatic input terminal 10, the conductive part 40 is configured to touch with the human body, the insulated part 50 is enclosed around the conductive part 40.

In this embodiment, the human body forms a loop with the electrostatic absorption circuit 20, the door handle 200 and the ground by touching the conductive part 40. Touching the conductive part 40 for a few seconds before touching the door handle 200, the electrostatic current in the door handle 200 will be absorbed by the electrostatic absorption circuit 20 and the ground through the loop. Then touching the door handle 200 will not produce static electricity. The conductive part 40 is isolated from the door handle 200 through the insulation part 50 to prevent human body from directly connecting to door handle 200 through the conductive part 40.

In one embodiment, the conductive part 40 is arranged on the lower side of the door handle 200.

When using the door handle 200, the user is usually used to hold the door handle 200 from below to open the door 300. In this embodiment, the conductive part 40 is arranged on the lower side of the door handle 200. When the human finger touches the conductive part 40, the action of holding the door handle 200 will be formed. After eliminating static electricity, the user can continue to open the door 300. Thus the user experience can be more smooth while eliminating static electricity.

In one embodiment, referring to FIG. 2, the electrostatic eliminating device 100 further comprises a switching element 60, the input end of the switching element 60 is configured to electrically connect with the door handle 200, the output end of the switching element 60 is electrically connected with the electrostatic input terminal 10, the controlled end of the switching element 60 is connected with the conductive part 40, the conductive part 40 is configured to trigger the switching element 60 to turn-on when pressed, to connect the door handle 200 and the electrostatic input terminal 10.

In one embodiment, the switching element 60 comprises a fixed part 62 and a telescopic part 61, the fixed part 62 is electrically connected with the electrostatic input terminal 10, the telescopic part 61 is fixedly connected with the conductive part 40, the telescopic part 61 can be located at a first position or a second position, the conductive part 40 is configured to drive the telescopic part 61 to move toward the door handle 200 when the conductive part 40 is pressed, so that the telescopic part 61 is in the second position, the conductive part 40 is also configured to drive the telescopic part 61 back to the first position (form the second position) when the pressure disappears.

In this embodiment, The switching element 60 can be a telescopic probe. The conducting part 40 can be set as press type. Initially, the conductive part 40 is not under pressure, and the telescopic part 61 is in the initial position and does not touch the door handle 200. When the conductive part 40 is pressed, the conductive part 40 drives the telescopic part 61 to move toward the door handle 200 to touch the door handle 200, so that the electrostatic charges on the door handle 200 can be transmitted to the electrostatic input terminal 10 through the switching element 60. When the pressure on the conductive part 40 disappears, the conductive part 40 returns to its initial position and drives the telescopic part 61 back to its initial position. There is an insulating connection between the telescopic part 61 and the conductive part 40, and the telescopic part 61 and the fixed part 62 are made of metal to conduct electrostatic charges.

In another embodiment, the switching element 60 can be an electromagnetic switch. The conductive part 40 can use a capacitance to sense the human body. When the human finger touches the conductive part 40, the conductive part 40 controls the switching element 60 to pull off to connect the door handle 200 and the electrostatic input terminal 10. When the human finger does not touch the conductive part 40, the switching element 60 is disconnected to disconnect the door handle 200 and the electrostatic input terminal 10.

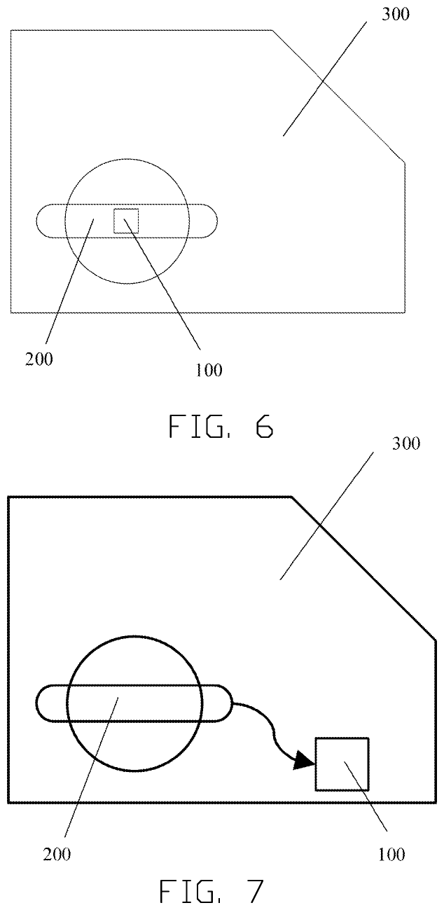

FIG. 6 is a diagram of a vehicle 1 in one embodiment of the present application.

The vehicle 1 comprises a door handle 200, a door 300 and an electrostatic eliminating device 100.

In one embodiment, the electrostatic eliminating device 100 is arranged on the door handle 200, to reduce the length of the connecting wire or etched metal wire between the door handle 200 and the electrostatic eliminating device 100, thus reducing the cost and process steps.

FIG. 7 is a diagram of a vehicle 1 in one embodiment of the present application.

In one embodiment, the electrostatic eliminating device 100 is arranged on the door. The specific position of electrostatic eliminating device 100 can be set according to the actual demand. For example, in order to make the vehicle 1 look beautiful, the door handle 200 and the door 300 can be designed as a smooth plane. At this time, the internal space of door handle 200 is limited, so the electrostatic eliminating device 100 can be set in the door handle 300 to save the space in the door handle 200.

The exemplary embodiments shown and described above are only examples. Many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. An electrostatic eliminating device, applied to a door handle of a vehicle, the electrostatic eliminating device comprising:
an electrostatic input terminal electrically connectable with the door handle;
an electrostatic absorption circuit, an input end of the electrostatic absorption circuit being electrically connected with the electrostatic input terminal, wherein the electrostatic absorption circuit is configured to absorb static electricity on the input end of the electrostatic absorption circuit; and
an electrostatic output terminal electrically connected with an output end of the electrostatic absorption circuit, the electrostatic output terminal being configured to be electrically connected to the door handle or to a human body.

2. The electrostatic eliminating device of claim 1, wherein the electrostatic absorption circuit comprises a first resistor, a first end of the first resistor is the input end of the electrostatic absorption circuit, a second end of the first resistor is the output end of the electrostatic absorption circuit, the first resistor is configured to absorb the static electricity on the input end.

3. The electrostatic eliminating device of claim 1, wherein the electrostatic absorption circuit comprises a second resistor and a third resistor, a first end of the second resistor is the input end of the electrostatic absorption circuit, the second resistor is configured to absorb the static electricity on the input end the second resistor, a first end of the third resistance is electrically connected with the second end of the second resistor to form the output end of the electrostatic absorption circuit, and a second end of the third resistance is grounded.

4. The electrostatic eliminating device of claim 3, wherein a resistance value of the second resistor is greater than a resistance value of the third resistor.

5. The electrostatic eliminating device of claim 3, the electrostatic eliminating device further comprising a conductive part and an insulated part, wherein the conductive part is arranged on an outer surface of the door handle, the conductive part is electrically connected with the electrostatic input terminal, the conductive part is configured to be in contact with the human body, the insulated part is enclosed around the conductive part.

6. The electrostatic eliminating device of claim 5, wherein the conductive part is arranged on a lower side of the door handle.

7. The electrostatic eliminating device of claim 5, the electrostatic eliminating device further comprising a switching element, wherein an input end of the switching element is configured to electrically connect with the door handle, an output end of the switching element is electrically connected with the electrostatic input terminal, a controlled end of the switching element is connected with the conductive part, and the conductive part is configured to trigger the switching element to turn on when the conductive part is pressed, such that the electrostatic input terminal is connected with the door handle.

8. The electrostatic eliminating device of claim 7, wherein the switching element comprises a fixed part and a telescopic part, the fixed part is electrically connected with the electrostatic input terminal, the telescopic part is fixedly connected with the conductive part, the conductive part is configured to drive the telescopic part to a second position so that the telescopic part moves toward the door handle when the conductive part is pressed, and the conductive part is further configured to drive the telescopic part to move from the second position to a first position when the conductive part is released.

9. A vehicle comprising a door handle; a door; and an electrostatic eliminating device, the electrostatic eliminating device comprising:
an electrostatic input terminal electrically connectable with the door handle;
an electrostatic absorption circuit, an input end of the electrostatic absorption circuit being electrically connected with the electrostatic input terminal, wherein the electrostatic absorption circuit is configured to absorb static electricity on the input end of the electrostatic absorption circuit; and
an electrostatic output terminal electrically connected with an output end of the electrostatic absorption circuit, the electrostatic output terminal being configured to be electrically connected to the door handle or to a human body.

10. The vehicle of claim 9, wherein the electrostatic eliminating device is arranged on the door handle, or the electrostatic eliminating device is arranged on the door.

11. The vehicle of claim 9, wherein the electrostatic absorption circuit comprises a first resistor, a first end of the first resistor is the input end of the electrostatic absorption circuit, a second end of the first resistor is the output end of the electrostatic absorption circuit, the first resistor is configured to absorb the static electricity on the input end.

12. The vehicle of claim 9, wherein the electrostatic absorption circuit comprises a second resistor and a third resistor, a first end of the second resistor is the input end of the electrostatic absorption circuit, the second resistor is configured to absorb the static electricity on the input end the second resistor, a first end of the third resistance is electrically connected with the second end of the second resistor to form the output end of the electrostatic absorption circuit, and a second end of the third resistance is grounded.

13. The vehicle of claim 11, wherein a resistance value of the second resistor is greater than a resistance value of the third resistor.

14. The vehicle of claim 11, the electrostatic eliminating device further comprising a conductive part and an insulated part, wherein the conductive part is arranged on an outer surface of the door handle, the conductive part is electrically connected with the electrostatic input terminal, the conductive part is configured to be in contact with the human body, the insulated part is enclosed around the conductive part.

15. The vehicle of claim 13, wherein the conductive part is arranged on a lower side of the door handle.

16. The vehicle of claim 14, the electrostatic eliminating device further comprising a switching element, wherein an input end of the switching element is configured to electrically connect with the door handle, an output end of the switching element is electrically connected with the electrostatic input terminal, a controlled end of the switching element is connected with the conductive part, and the conductive part is configured to trigger the switching element to turn on when the conductive part is pressed, such that the electrostatic input terminal is connected with the door handle.

17. The vehicle of claim 16, wherein the switching element comprises a fixed part and a telescopic part, the fixed part is electrically connected with the electrostatic input terminal, the telescopic part is fixedly connected with the conductive part, the conductive part is configured to drive the telescopic part to a second position so that the telescopic part moves toward the door handle when the conductive part is pressed, and the conductive part is further configured to drive the telescopic part to move from the second position to a first position when the conductive part is released.
